(19) United States
(12) Patent Application Publication
(10) Pub. No.: US 2012/0113452 A1
(43) Pub. Date: May 10, 2012

(54) IMAGE PROCESSING APPARATUS, SYSTEM, IMAGE PROCESSING METHOD, AND RECORDING MEDIUM

(75) Inventor: Yoshihiro TAKESHITA, Kanagawa (JP)

(73) Assignee: FUJI XEROX CO., LTD., Tokyo (JP)

(21) Appl. No.: 13/232,631

(22) Filed: Sep. 14, 2011

(30) Foreign Application Priority Data
Nov. 10, 2010 (JP) 2010-251891

(51) Int. Cl. G06K 15/02

(52) U.S. Cl. 358/1.13

(57) ABSTRACT

An image processing apparatus includes a table holding unit that holds a power consumption table in which a premeasured power consumption value is registered for each of functions provided by the image processing apparatus, a power consumption computing unit that computes, using the power consumption table, power consumed when a process using at least one of the functions is performed, and a memory that stores information regarding the power consumption in association with the performed process.

### CROSS-REFERENCE TO RELATED APPLICATIONS

This application is based on and claims priority under 35 USC 119 from Japanese Patent Application No. 2010-251891 filed Nov. 10, 2010.

### BACKGROUND

### Technical Field

The present invention relates to an image processing apparatus, a system, an image processing method, and a recording medium.

### SUMMARY

According to an aspect of the invention, there is provided an image processing apparatus including a table holding unit that holds a power consumption table in which a premeasured power consumption value is registered for each of functions provided by the image processing apparatus, a power consumption computing unit that computes, using the power consumption table, power consumed when a process using at least one of the functions is performed, and a memory that stores information regarding the power consumption in association with the performed process.

### BRIEF DESCRIPTION OF THE DRAWINGS

Exemplary embodiments of the present invention will be described in detail based on the following figures, wherein:

FIG. 1 illustrates an exemplary hardware configuration of an image processing apparatus according to an exemplary embodiment of the invention;

FIG. 2 illustrates an exemplary configuration of a power consumption management unit according to a first exemplary embodiment;

FIG. 3 illustrates an exemplary structure of a power consumption table according to the first exemplary embodiment;

FIG. 4 is a flowchart of the operation performed by the power consumption management unit when the power consumption management unit computes power consumption and stores information regarding the power consumption required for job execution;

FIG. 5 illustrates an exemplary structure of the power consumption table held in a table holding sub-unit of the power consumption management unit according to a second exemplary embodiment;

FIG. 6 illustrates an exemplary functional configuration according to a third exemplary embodiment;

FIG. 7 illustrates an example of instructions describing cooperation definition information;

FIG. 8 illustrates the cooperation definition information after editing is performed by a cooperation definition information editing unit according to the third exemplary embodiment;

FIG. 9 illustrates the cooperation definition information after editing is performed by the cooperation definition information editing unit when an apparatus D is in a power saving mode; and

FIG. 10 illustrates another example of the functional configuration according to the third exemplary embodiment.

### DETAILED DESCRIPTION

Exemplary embodiments of the invention are described below with reference to the accompanying drawings.

### Image Processing Apparatus

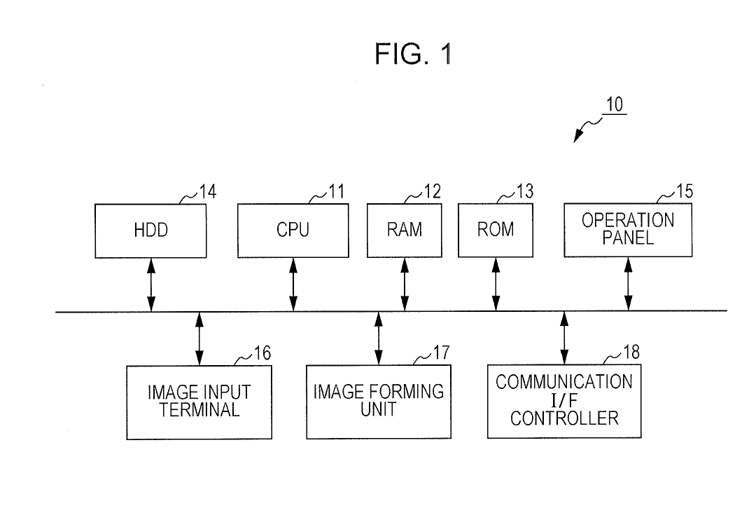

FIG. 1 illustrates an exemplary hardware configuration of an image processing apparatus according to an exemplary embodiment of the invention. As illustrated in FIG. 1, an image processing apparatus 10 includes a central processing unit (CPU) 11, a random access memory (RAM) 12, a read only memory (ROM) 13, a hard disk drive (HDD) 14, an operation panel 15, an image input terminal 16, an image forming unit 17, and a communication interface controller (hereinafter simply referred to as a “communication I/F controller”) 18.

The CPU 11 loads a variety of programs stored in, for example, the ROM 13 into the RAM 12 and executes the programs. Thus, functions described below are realized. The RAM 12 is a memory used as a working memory for the CPU 11. The ROM 13 is a memory that stores, for example, a variety of programs to be executed by the CPU 11. For example, the HDD 14 is a magnetic disk unit that stores image data read by the image input terminal 16 and image data to be used for image formation performed by the image forming unit 17. For example, the operation panel 15 is a touch panel that displays a variety of information items and receives an operational input from a user.

The image input terminal 16 reads an image recorded on a recording medium, such as paper. For example, the image input terminal 16 is a scanner. The scanner can employ a CCD method in which the size of a reflected light beam of a beam emitted from a light source onto a document is reduced by using a lens and is received by charge coupled devices (CCDs) or a CIS (contact image sensor) method in which a reflected light beam of a beam sequentially emitted from an LED light source onto a document is received by a CIS.

The image forming unit 17 forms an image on a recording medium. For example, a printer serves as the image forming unit. The printer can employ an electrophotographic image forming method in which toner deposited on a photosensitive member is transferred onto a recording medium and an image is formed or an inkjet image forming method in which ink is ejected onto a recording medium and an image is formed. The communication I/F controller 18 receives and transmits a variety of information items from and to other apparatuses via a network.

According to the present exemplary embodiment, in the image processing apparatus 10, the CPU 11 loads a program stored in the ROM 13 into the RAM 12 and executes the program. In this way, a power consumption management unit 20 is provided, which is an example of a power consumption management system that manages information regarding power consumption required when a variety of jobs (processes) are executed. Several exemplary embodiments are described below in accordance with a way of outputting the power consumption information and how to use the power consumption information.

### First Exemplary Embodiment

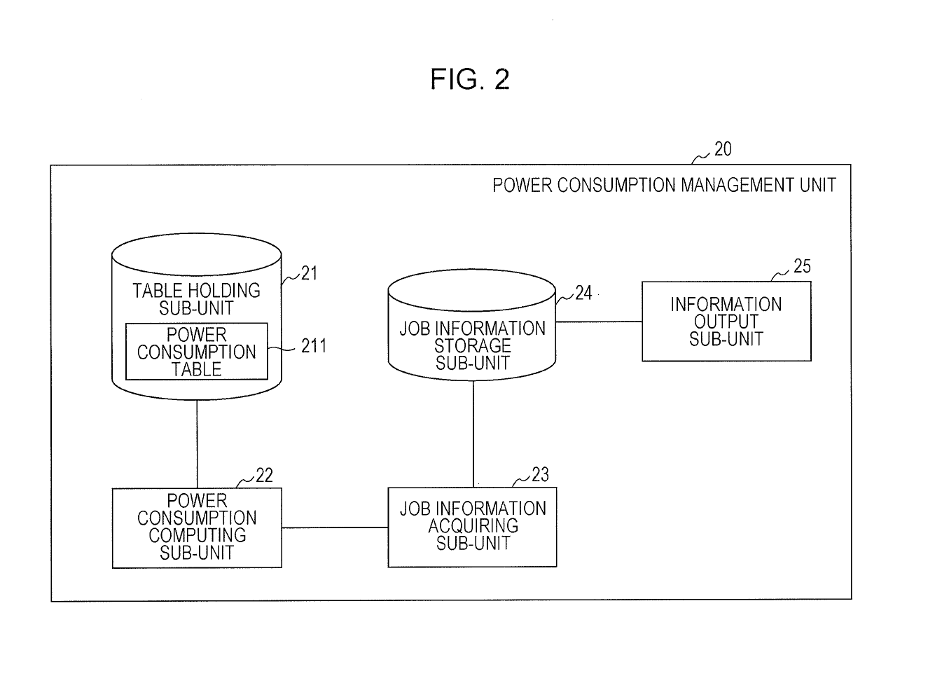

FIG. 2 illustrates an exemplary configuration of the power consumption management unit 20 according to the first exemplary embodiment. As illustrated in FIG. 2, the power consumption management unit 20 includes a table holding sub-unit 21, a power consumption computing sub-unit 22, a job information acquiring sub-unit 23, a job information storage sub-unit 24, and an information output sub-unit 25. The table holding sub-unit 21 and the job information storage sub-unit 24 are formed from a storage unit, such as the HDD (refer to FIG. 1). In addition, the functions of the power consumption computing sub-unit 22, the job information acquiring sub-unit 23, and the information output sub-unit 25 are realized by the CPU 11 (refer to FIG. 1) that loads the program from the ROM 13 (refer to FIG. 1) into the RAM 12 (refer to FIG. 1) and executes the program.

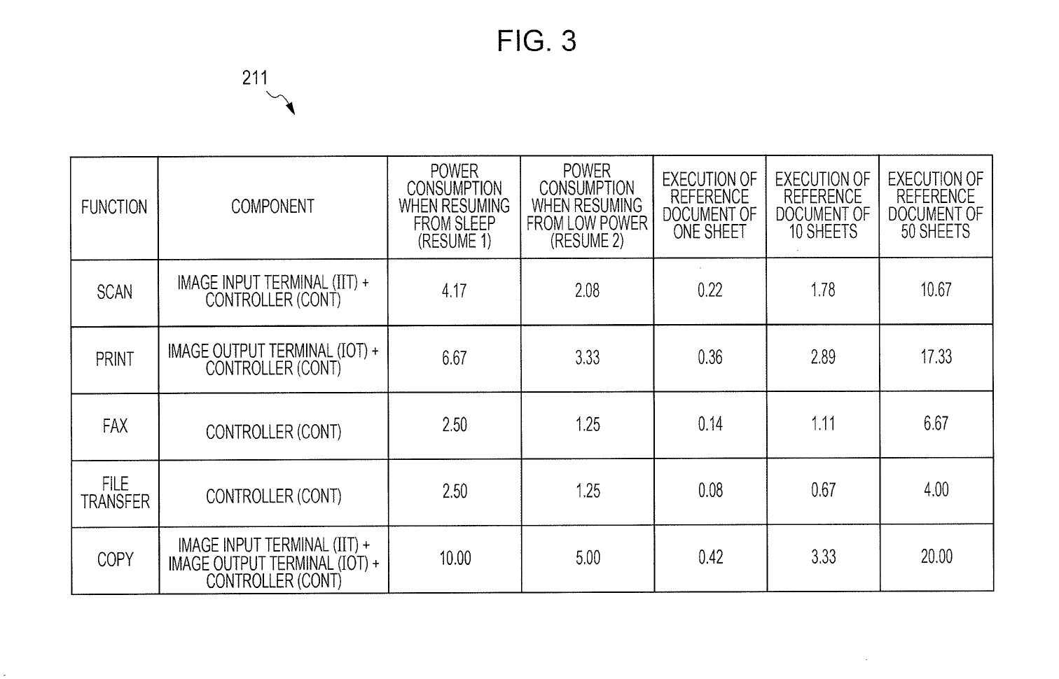

The table holding sub-unit 21 holds a power consumption table 211. The power consumption table 211 registers, therein, power consumed for each of the functions of the image processing apparatus 10 when the function is used. FIG. 3 illustrates an exemplary structure of the power consumption table 211. In the power consumption table 211 illustrated in FIG. 3, power consumed for each of the functions “Scan”, “Print”, “FAX”, “File transfer”, and “Copy” under various use conditions is registered. More specifically, the table illustrated in FIG. 3 contains power consumed when three types of operations are performed (i.e., a reference document of one sheet, a reference document of 10 sheets, and reference document of 50 sheets are executed) after the image processing apparatus 10 is in a standby mode. These power consumption values are obtained by measuring the power consumption when the functions are performed under a predetermined test environment (an operating environment).

As used herein, the term “reference document” refers to a document prepared for measuring the power consumption. The information (an image) printed on a sheet is determined so as to be suitable for measuring power consumption. In addition, the term “execution of x sheets” refers to reading of a reference document of x sheets in the case of the function “Scan”. Similarly, the term “execution of x sheets” refers to printing and outputting of a reference document of x sheets in the case of the function “Print”. The term “execution of x sheets” refers to faxing of a reference document of x sheets in the case of the function “FAX”. The term “execution of x sheets” refers to transferring of a data file including a reference document of x sheets to another information apparatus in the case of the function “File Transfer”. The term “execution of x sheets” refers to copying of a reference document of x sheets (reading of the document and outputting of a printed document) in the case of the function “Copy”. Note that in the example illustrated in FIG. 3, the registered values are based on a single reference document. However, plural reference documents may be prepared on the basis of the size of a sheet, the type of sheet, the type of an image, or the like, and a power consumption value may be registered for each of the reference documents.

When the image processing apparatus 10 performs a process, power consumption is not always proportional to the amount of the process (the amount of a document read or printed and output, or the amount of data transmitted). For example, in the case of printing and outputting a document using an electrophotographic image forming method using toner as an image forming material, an operation to transport a sheet from a paper feed tray to a paper output tray via a developing unit and a fixing unit, an operation to form an image and transfer the image onto the sheet in the developing unit, and an operation to fix toner onto the sheet by applying heat to the toner in the fixing unit are performed in order to perform the function.

If a document of plural sheets is printed and output, a second sheet and sheets subsequent thereto are not transported immediately after the previous sheet has been ejected but are sequentially transported at appropriate intervals. Accordingly, even when a document of 10 sheets is printed and output, the amount of operation to transport the sheets is not simply ten times the amount of operation of printing and outputting a document of one sheet. In addition, after the temperature of the fixing unit has reached a necessary temperature, the fixing unit only needs to maintain the temperature. That is, the fixing unit need not raise the temperature every time a sheet onto which a toner image is fixed is reached. Therefore, in general, the power consumption for executing a document of x sheets for a certain function is smaller than x times the power consumption for executing a document of one sheet.

Accordingly, the table illustrated in FIG. 3 contains the power consumption values required under the following three conditions: execution of a document of one sheet, a document of 10 sheets, and a document of 50 sheets. Note that these conditions are only illustrative. The table may contain the power consumption values under other conditions. For example, the number of the conditions may be increased, and the power consumption values for execution of a document of five sheets and a document of 20 sheets may be registered. Furthermore, in consideration of high volume printing, the power consumption values for execution of a document of 100 sheets and a document of 1000 sheets may be registered.

In addition, as illustrated in FIG. 3, a power consumption table 211 further contains the power consumption value required when the image processing apparatus 10 enters an operable mode from a power saving mode. The power saving mode may include multi-stage sub-modes in which the power consumption is lower than that in a normal mode and the power consumption decreases step by step from a certain set sub-step.

According to the present exemplary embodiment, the power saving mode includes a sleep mode in which a network interface is powered on so as to receive a signal from the network and the other hardware components are powered off and a low-power consumption mode in which some of the hardware components are powered on in addition to the network interface. The following description is made under the two-mode condition.

According to the present exemplary embodiment, the power consumption table 211 illustrated in FIG. 3 contains the power consumption values required when the image processing apparatus 10 returns from a sleep mode to an operable mode (refer to “Power Consumption When Resuming from Sleep” in FIG. 3) and the power consumption values required when the image processing apparatus 10 returns from a low power mode to an operable mode (refer to “Power Consumption When Resuming from Low Power” in FIG. 3). In a power saving mode, such as a sleep mode or the low power mode, supply of electrical power to some of the components of the image processing apparatus 10 is shut off. Therefore, in order to perform a process using a specific function of the image processing apparatus 10, power needs to be supplied to the devices used for performing the necessary function so that the devices enter the normal standby mode before the process is performed. In addition, in general, the power saving mode includes plural stepwise sub-modes, and control is performed so that, as a period of time during which a process is not performed is longer, power consumption is reduced by stopping supply of power to the increasing number of component devices. In the example illustrated in FIG. 3, two stages (i.e., a sleep mode and a low power mode) are set. The power consumption values required when the image processing apparatus 10 resumes from a sleep mode and a low power mode are registered in the power consumption table 211.

Furthermore, the power consumption table 211 illustrated in FIG. 3 contains information regarding the component devices of the image processing apparatus 10 used for performing the processes of each of the functions. More specifically, for the function “Scan”, an image input terminal (e.g., the image input terminal 16 illustrated in FIG. 1) and a controller (e.g., the CPU 11, the RAM 12, and the ROM 13 illustrated in FIG. 1) are used. For the function “Print”, an image output terminal (e.g., the image forming unit 17 illustrated in FIG. 1) and the controller are used. In addition, for the function “Fax” or “File Transfer”, a controller (e.g., the communication I/F controller 18 and a modem (not illustrated) in addition to the CPU 11, the RAM 12, and the ROM 13 illustrated in FIG. 1) is used. For the function “Copy”, the image input terminal, the image output terminal, and the controller are used.

The power consumption computing sub-unit 22 computes, using the power consumption table 211, the power consumption needed when the image processing apparatus 10 executes a job. For example, the case in which the image processing apparatus 10 in a standby mode prints and outputs a document of 15 sheets (executes a job) is discussed. In such a case, the power consumption table 211 illustrated in FIG. 3 indicates that a power consumption of “2.89 W (Watts)” is required for execution of 10 sheets and the power consumption of “0.36 W” is required for execution of one sheet. If it is assumed that the power consumption required for execution of 5 sheets is five times that for execution of one sheet, the power consumption required for execution of 15 sheets is 4.69 (=2.89+0.36×5) W.

Note that when a job is executed, the power consumption computing sub-unit 22 does not measure the actual power consumed during execution of the job, but the power consumption computing sub-unit 22 computes power consumption on the basis of the information in the power consumption table 211 prepared in accordance with the executed job. Accordingly, the power consumption computing sub-unit 22 may compute the power consumption on the basis of the information in a job execution instruction received by the image processing apparatus 10 without waiting for actual execution of the job.

The job information acquiring sub-unit 23 acquires information regarding the job executed by the image processing apparatus 10 (hereinafter referred to as “job information”). More specifically, the job information acquiring sub-unit 23 extracts, from a job execution instruction, job property information, such as the type of function, the number of sheets to be executed, and the identification information on the submitter of the instruction (a user). Thus, the job information acquiring sub-unit 23 acquires such job property information. When the job is actually executed, the job information acquiring sub-unit 23 further acquires the operational information regarding job execution, such as the date and time and information as to whether the image processing apparatus 10 has resumed from a power saving mode. Still furthermore, the job information acquiring sub-unit 23 acquires status information indicating the result of job execution and information regarding resources consumed during the job execution (e.g., the number of sheets and the amount of toner). In some cases, the job information acquiring sub-unit 23 further acquires an executed image (data). Note that the job execution instruction may be input from the operation panel 15 illustrated in FIG. 1 or may be transmitted from a client terminal and may be input via the communication I/F controller 18.

The job information storage sub-unit 24 stores the job information acquired by the job information acquiring sub-unit 23 together with the job identification information for each of the jobs executed by the image processing apparatus 10. In addition, according to the present exemplary embodiment, the job information storage sub-unit 24 stores power consumption information computed by the power consumption computing sub-unit 22 for each of the jobs in association with the above-described job information (i.e., in association with the job).

The information output sub-unit 25 reads, from the job information stored in the job information storage sub-unit 24, information regarding power consumption (power consumption information) of a specific job on the basis of a particular extraction condition and outputs the readout information. The output information may be displayed on a display provided in the image processing apparatus 10. Alternatively, the output information is transmitted to a client terminal connected to the image processing apparatus 10 via the communication I/F controller 18.

The information regarding power consumption may be extracted on the basis of a variety of conditions in addition to each of the jobs. For example, if the job information includes information for identifying a person who has input the job execution instruction (i.e., a user), information indicating the accumulated power consumption for each of the users can be extracted for a predetermined period of time. Alternatively, information indicating the accumulated power consumption for a group or a department to which the user belongs may be output. In addition to the information regarding power consumption, the information output sub-unit 25 may output an alert message or a warning message to a specific user (or a group or a department) who has consumed a large amount of electricity.

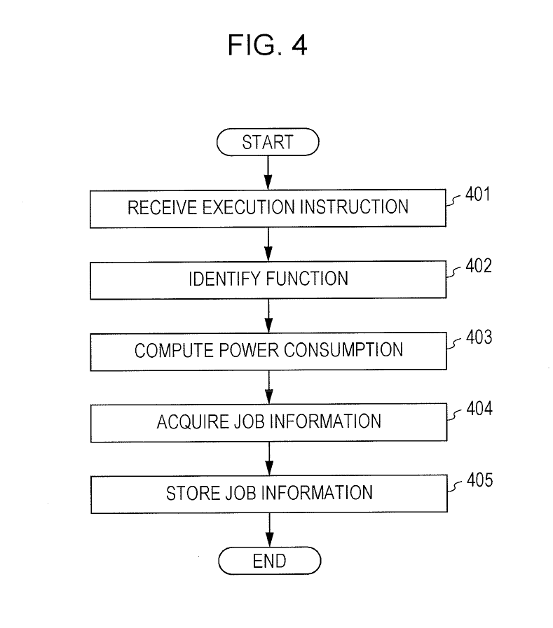

FIG. 4 is a flowchart of the operation performed by the power consumption management unit 20 when the power consumption management unit 20 computes the power consumption and stores information regarding the power consumption required for job execution. When the image processing apparatus 10 receives a job execution instruction (step 401), the power consumption management unit 20 analyzes the job execution instruction and identifies the function required for executing the job (step 402). Thereafter, the power consumption computing sub-unit 22 refers to the power consumption table 211 and computes the power consumption required for execution of the job (step 403). In addition, the job information acquiring sub-unit 23 acquires the job information on the basis of the results of job analysis and job execution (step 404). Furthermore, the job information acquiring sub-unit 23 instructs the job information storage sub-unit 24 to store the power consumption value computed by the power consumption computing sub-unit 22 in association with the job information on the corresponding job acquired in step 404 (step 405). That is, the job information acquiring sub-unit 23 also functions as a storage unit for storing job information and power consumption information in the job information storage sub-unit 24.

Subsequently, when the image processing apparatus 10 receives an output instruction including conditions regarding the job and the user who has input the job execution instruction, the information output sub-unit 25 reads, from the job information storage sub-unit 24, the job information that satisfies the conditions included in the output instruction. Thereafter, the information output sub-unit 25 displays the job information and the power consumption information associated with the job information on, for example, the display.

### Second Exemplary Embodiment

In the first exemplary embodiment, the power consumption management unit 20 of the image processing apparatus 10 includes the power consumption table 211 having power consumption information registered therein and used when the function of the image processing apparatus 10 is used. Thus, the power consumption management unit 20 computes power consumption required when the image processing apparatus 10 executes a job. In contrast, according to the second exemplary embodiment, a power consumption management unit 20 includes information regarding power consumption required when the function of another image processing apparatus is executed in addition to power consumption information regarding the image processing apparatus 10.

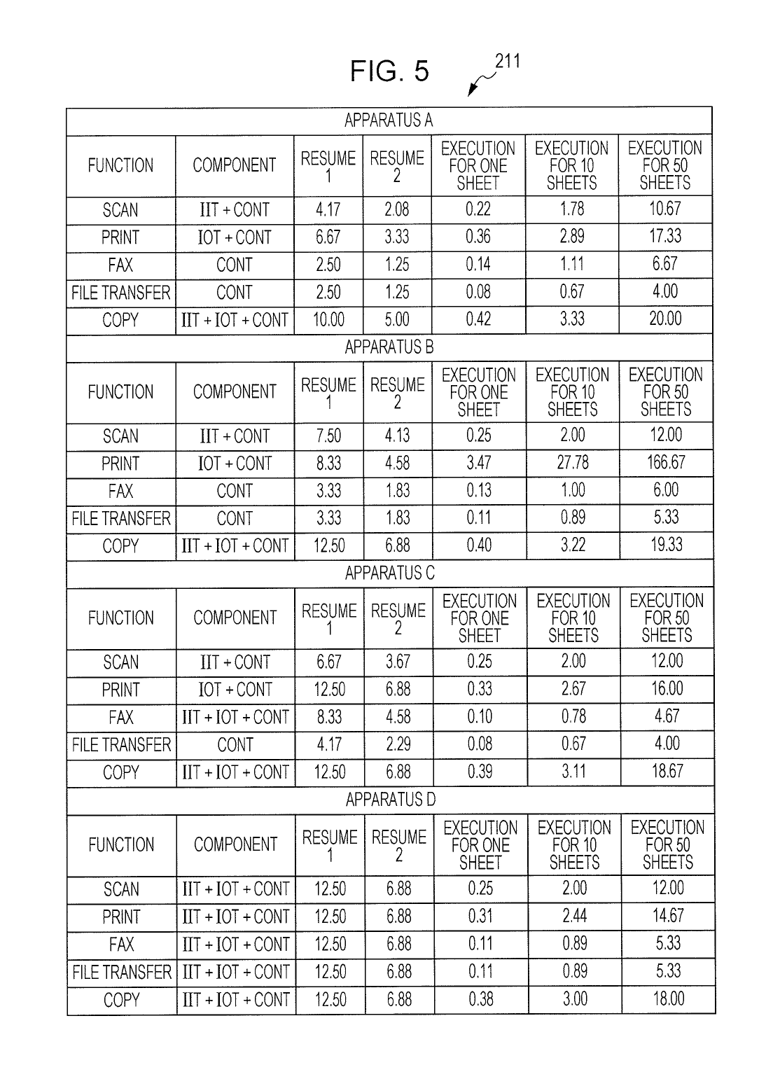

FIG. 5 illustrates an example of the structure of the power consumption table 211 held in the table holding sub-unit 21 of the power consumption management unit 20 according to the second exemplary embodiment. As illustrated in FIG. 5, the power consumption table 211 contains power consumption values required for each of the functions for four image processing apparatuses 10 (apparatuses A, B, C, and D). If the power consumption table 211 illustrated in FIG. 5 is held in the table holding sub-unit 21 of the power consumption management unit 20 of the apparatus A, the table information registered for the apparatus A is the power consumption information regarding the apparatus A itself, and the table information registered for the apparatuses B, C, and D is the power consumption information used for other apparatuses (i.e., image processing apparatuses other than the apparatus A).

Note that in FIG. 5, the items of power consumption information are appropriately abbreviated. More specifically, the item “Power Consumption When Resuming from Sleep” is represented as “Resume 1”, and the item “Power Consumption When Resuming from Low Power” is represented as “Resume 2”. In addition, in the items regarding power consumption in accordance with the number of sheets of a reference document to be executed, the word “reference document” is removed. Furthermore, in FIG. 5, in the item “component device” for each of the functions, only abbreviated names “IIT” (Image Input Terminal) for an image reading unit, “IOT” (Image Output Terminal) for an image output unit, and “Cont” for a controller are illustrated.

In the second exemplary embodiment, the power consumption computing sub-unit 22 computes power consumption of the apparatus A and power consumption of the other apparatuses using the power consumption table 211 illustrated in FIG. 5. More specifically, upon receiving an execution instruction for a job, the power consumption computing sub-unit 22 computes power consumption of another apparatus having a function that can execute the job.

A job information acquiring sub-unit 23 is similar to the job information acquiring sub-unit 23 of the first exemplary embodiment. The job information acquiring sub-unit 23 acquires job information from the job extraction instruction and the result of job execution. The job information storage sub-unit 24 stores the job information acquired by the job information acquiring sub-unit 23 in association with the power consumption information computed by the power consumption computing sub-unit 22 for the apparatus A and the other apparatuses B, C, and D.

Like the information output sub-unit 25 of the first exemplary embodiment, an information output sub-unit 25 reads out the power consumption information on the basis of a particular extraction condition and outputs the readout power consumption information. In addition, according to the second exemplary embodiment, if the power consumption of the apparatuses other than the apparatus A computed for the particular job by the power consumption computing sub-unit 22 is smaller than that of the apparatus A, the information output sub-unit 25 outputs a message (apparatus information) indicating this fact to the user. More specifically, for example, the values of the power consumption are displayed or information regarding the apparatuses having power consumption values smaller than that of the apparatus A is displayed on the display of the image processing apparatus 10 or the client terminal. Alternatively, a message prompting the user to execute the job using another apparatus having smaller power consumption may be displayed.

In general, the power consumption value is computed by the power consumption computing sub-unit 22 when a job is executed. Therefore, according to the present exemplary embodiment, the power consumption information computed when a job is executed is stored in the job information storage sub-unit 24. Thereafter, if a job execution instruction for a job of the same type is received, the information output sub-unit 25 generates the above-described apparatus information and outputs the apparatus information. However, in the case where the processing speed of the CPU 11 (refer to FIG. 1) of the image processing apparatus 10 (the apparatus A) is high, when a job execution instruction is received, the power consumption computing sub-unit 22 may compute power consumption of the apparatus A and the other apparatuses before executing the job, generate the above-described apparatus information, and output the apparatus information.

An example of the apparatus information is described in more detail next. The case in which the image processing apparatus 10 corresponding to the apparatus A illustrated in FIG. 5 prints a document of one sheet and outputs the document is discussed below. The power consumption table 211 illustrated in FIG. 5 indicates that in order to print and outputs a document of one sheet, the apparatus A consumes 0.36 W, the apparatus B consumes 3.47 W, the apparatus C consumes 0.33 W, and the apparatus D consumes 0.31 W. Therefore, when the job is executed, the information output sub-unit 25 generates apparatus information indicating that power consumption can be reduced by using the apparatus C or D instead of the apparatus A. Thereafter, the information output sub-unit 25 outputs the apparatus information.

More specifically, the apparatus information presented to the user may include the identification information on the apparatus C and the apparatus D that have power consumption smaller than that of the apparatus A or only the identification information on the apparatus D that has the smallest power consumption. Alternatively, the apparatus information may include the power consumption value required when each of the image processing apparatuses 10 executes the job together with the identification information on the image processing apparatus 10. Still alternatively, the apparatus information may include only the power consumption values required when the image processing apparatuses 10 execute the job, since that information helps the user select one of the image processing apparatuses 10. Yet still furthermore, a message indicating that power consumption can be reduced if the user selects the apparatus C or D that has power consumption smaller than that of the apparatus A or a message prompting the user to select the apparatus C or D may be generated and output as the apparatus information.

In addition, if the image processing apparatus 10 is in a power saving mode, such as a sleep mode or a low power mode, power consumption required for executing a job needs to be computed by adding the power consumed when the image processing apparatus 10 resumes from the power saving mode to a normal standby mode. As illustrated in FIG. 5, the power consumed when the image processing apparatus 10 resumes from the sleep mode of each of the apparatuses C and D (resume 1) is 12.50 W, and the power consumed when the image processing apparatus 10 resumes from the low power mode of each of the apparatuses C and D (resume 2) is 6.88 W. That is, in the above-described example in which a document of one sheet is printed and output, if the power consumed when the image processing apparatus 10 resumes from either the sleep mode or the low power mode is added, the power consumption of either the apparatus C or the apparatus D is larger than that required when the apparatus A executes the job. Accordingly, when a job is executed and if the other image processing apparatuses 10 are in a power saving mode, it is necessary for the image processing apparatus 10 to generate apparatus information on the basis of the power consumption computed by adding the power consumed for a resuming operation. Note that the mode of each of the other image processing apparatuses 10 connected to a network (i.e., whether the image processing apparatus 10 is in a power saving mode or not) can be determined by, for example, exchanging data among the image processing apparatuses 10, via the network and checking the mode.

### Third Exemplary Embodiment

Like the second exemplary embodiment, according to a third exemplary embodiment, the power consumption management unit 20 holds power consumption information regarding the image processing apparatus 10 including the power consumption management unit 20 and power consumption information regarding the other apparatuses. In addition, according to the third exemplary embodiment, the image processing apparatus 10 is connected to the other image processing apparatuses 10 via a network and performs a cooperative process in which a process is performed in cooperation with plural apparatuses.

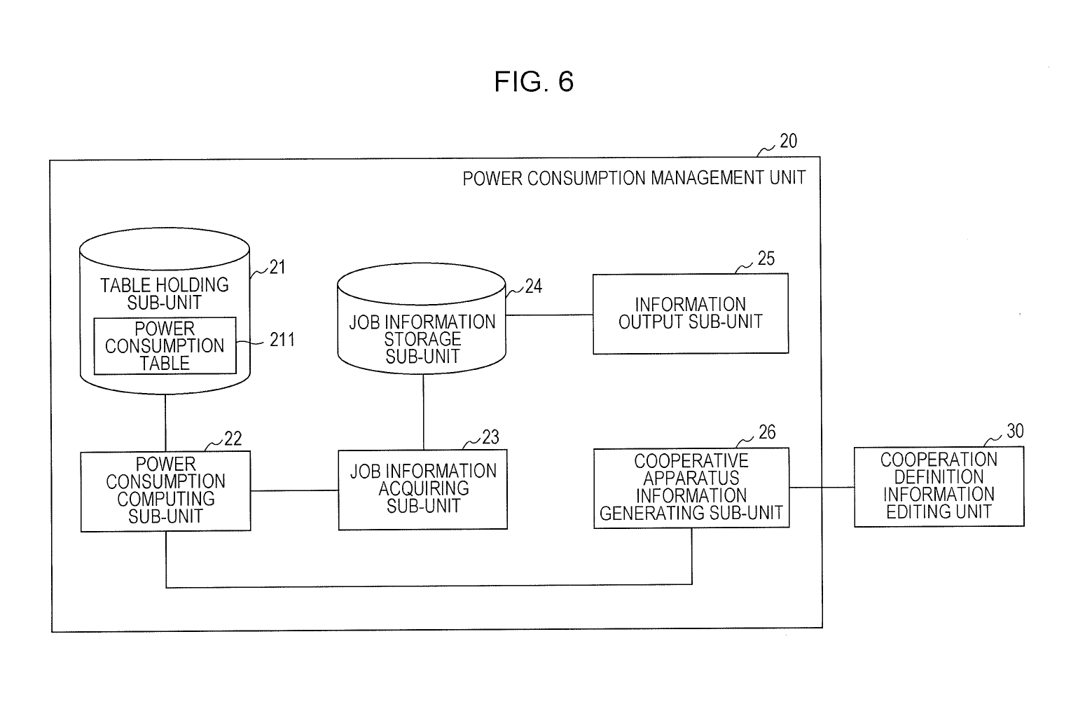

FIG. 6 illustrates an exemplary functional configuration according to the third exemplary embodiment. As illustrated in FIG. 6, the power consumption management unit 20 according to the third exemplary embodiment includes a cooperative apparatus information generating sub-unit 26 in addition to the table holding sub-unit 21, the power consumption computing sub-unit 22, the job information acquiring sub-unit 23, the job information storage sub-unit 24, and the information output sub-unit 25. Furthermore, according to the third exemplary embodiment, as illustrated in FIG. 6, the power consumption management unit 20 is connected to a cooperation definition information editing unit 30. The functions of the cooperative apparatus information generating sub-unit 26 and the cooperation definition information editing unit 30 are realized, for example, when, in the image processing apparatuses 10 illustrated in FIG. 1, the CPU 11 loads a program stored in the ROM 13 into the RAM 12 and executes the program.

The cooperative process and the cooperation definition information are described in more detail next. As used herein, the term “cooperative process” refers to a series of plural sub-processes performed in sequence. In general, the sub-processes of a cooperative process are performed by the plural image processing apparatuses 10. However, the sub-processes need not be performed by the different image processing apparatuses 10. A single image processing apparatus 10 may perform the series of sub-processes.

As used herein, the term “cooperation definition information” refers to information indicating which sub-process of the above-described cooperative process is performed by which image processing apparatus 10 and the position of the sub-process in the order in which the sub-processes are performed. The image processing apparatus 10 analyzes the cooperation definition information, and the sub-processes are performed. In this way, a cooperative process is performed by one of the image processing apparatuses 10 or the plural image processing apparatuses 10. A cooperative process can be performed in a variety of ways. For example, a cooperative process execution instruction may have cooperation definition information attached thereto, and the cooperative process execution instruction may be exchanged among the image processing apparatuses 10. That is, one of the image processing apparatuses 10 may receive an execution instruction having the cooperation definition information attached thereto and may perform a sub-process assigned thereto. Subsequently, the image processing apparatus 10 may send an execution instruction having the cooperation definition information attached thereto to the image processing apparatus 10 that should perform the next sub-process. Such an operation is repeated. At that time, image data processed by the image processing apparatus 10 may be sent together with the execution instruction having the cooperation definition information attached thereto and to be sent to the image processing apparatus 10 that should perform the next sub-process. Alternatively, a control apparatus that controls all of the image processing apparatuses 10 may have the cooperation definition information and may control the image processing apparatuses 10 in accordance with the cooperation definition information. In this way, the series of sub-processes may be performed. According to the present exemplary embodiment, description is made with reference to a cooperative process performed by sequentially sending the cooperation definition information to the next image processing apparatus 10.

Like the second exemplary embodiment, in the power consumption management unit 20 illustrated in FIG. 6, the table holding sub-unit 21 holds the power consumption table 211 illustrated in FIG. 5. However, in the third exemplary embodiment, the other apparatuses registered in the power consumption table 211 include the image processing apparatuses 10 that can perform a cooperative process together with the image processing apparatus 10 having the power consumption table 211.

The power consumption computing sub-unit 22 computes, using the power consumption table 211 illustrated in FIG. 5, power consumption required for the apparatus including the power consumption computing sub-unit 22 and the other cooperative apparatuses when the job is executed. In addition, according to the third exemplary embodiment, when the image processing apparatus 10 receives a cooperative process execution instruction, the power consumption computing sub-unit 22 computes, for each of the jobs forming the cooperative process, electricity consumed by the apparatus including the power consumption computing sub-unit 22 and the other cooperative apparatuses when the job is executed.

The job information acquiring sub-unit 23 is similar to the job information acquiring sub-unit 23 of the first exemplary embodiment. The job information acquiring sub-unit 23 acquires job information on the basis of a job execution instruction and the result of job execution. The job information storage sub-unit 24 stores the job information acquired by the job information acquiring sub-unit 23 in association with the power consumption information regarding the apparatus and the other apparatuses computed by the power consumption computing sub-unit 22.

Like the information output sub-unit 25 of the first exemplary embodiment, the information output sub-unit 25 reads out the power consumption information on the basis of a particular extraction condition. In addition, like the information output sub-unit 25 of the second exemplary embodiment, if another apparatus having power consumption lower than that of the apparatus is found for a particular job, the information output sub-unit 25 may output information (apparatus information) that informs the user of selection of another apparatus.

The cooperative apparatus information generating sub-unit 26 generates information regarding the image processing apparatus 10 (an execution responsible apparatus) that executes one of the jobs that form the cooperative process on the basis of the power consumption of each of the image processing apparatuses 10 for each of the jobs computed by the power consumption computing sub-unit 22. More specifically, the cooperative apparatus information generating sub-unit 26 selects one of the image processing apparatuses 10 that consumes the lowest electricity for each of the jobs and generates correspondence information between the selected image processing apparatus 10 and the job. That is, the cooperative apparatus information generating sub-unit 26 functions as a determination unit for determining the image processing apparatus 10 serving as an execution responsible apparatus that executes each of the jobs.

The cooperation definition information editing unit 30 edits and updates, on the basis of the apparatus information generated by the cooperative apparatus information generating sub-unit 26, the cooperation definition information in the cooperative process execution instruction received by the image processing apparatus 10 as needed. More specifically, if, among a series of jobs that form the cooperative process, the image processing apparatus 10 defined as the image processing apparatus 10 that executes one of the jobs in the cooperation definition information differs from the image processing apparatus 10 selected by the cooperative apparatus information generating sub-unit 26, the cooperation definition information editing unit 30 updates the cooperation definition information so that the apparatus information selected by the cooperative apparatus information generating sub-unit 26 is employed. That is, for each of the sub-processes that form the cooperation definition information, editing is performed so that an image processing apparatus defined as an apparatus that performs the sub-process is replaced with the image processing apparatus 10 that consumes the lowest electricity and that is selected by the cooperative apparatus information generating sub-unit 26.

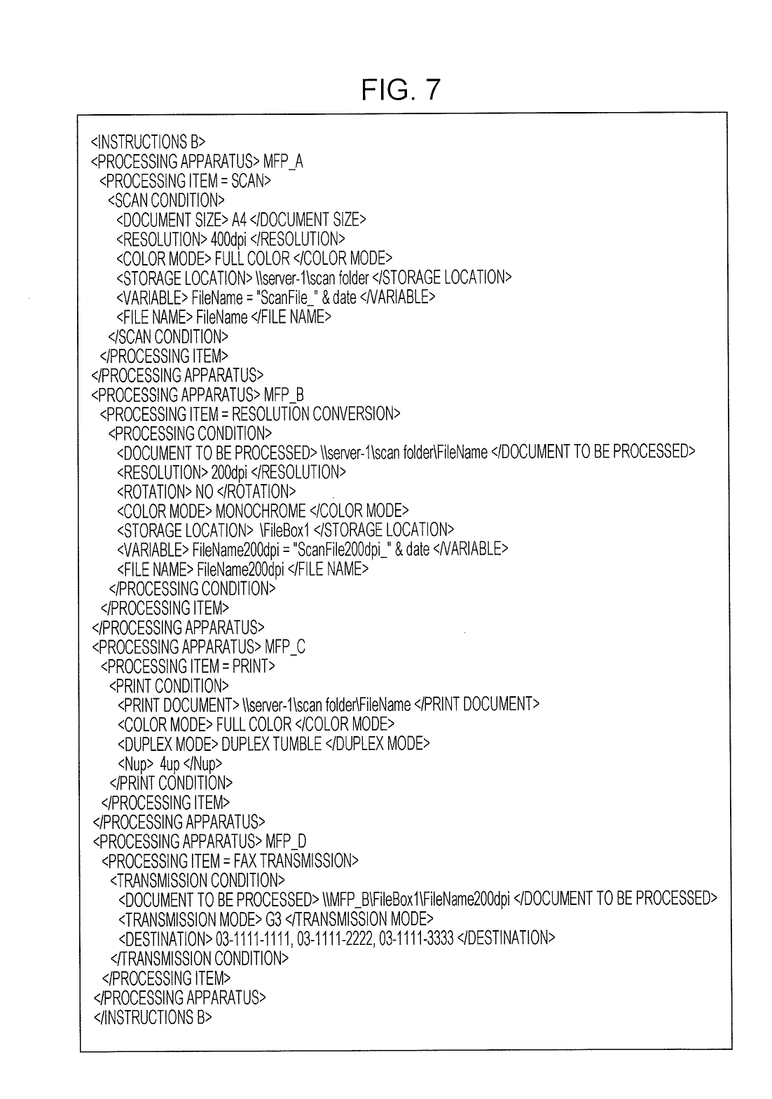

Editing of the cooperation definition information is described in more detail below with reference to a particular example of the cooperation definition information. FIG. 7 illustrates an example of instructions describing the cooperation definition information. The cooperation definition information illustrated in FIG. 7 is used for executing a cooperative process including four jobs, namely, “Scan”, “Resolution Conversion”, “Print and Output (Print)”, and “FAX (Fax Transmission)” using four image processing apparatuses 10, namely, an apparatus A (MFP_A), an apparatus B (MFP_B), an apparatus C (MFP_C), and an apparatus D (MFP_D). Note that the apparatuses A, B, C, and D represent the image processing apparatuses 10 registered in the power consumption table 211 illustrated in FIG. 5.

As illustrated in FIG. 7, the image processing apparatus 10 indicated by a <processing apparatus> tag executes a sub-process (a job) indicated by a <processing item> tag under the condition indicated by “Processing Condition”. The “processing condition” is described as one of <Scan Condition>, <Print Condition>, and <Transmission Condition”>. For example, according to the description between “<processing apparatus> MFP_A” in line 2 to “</processing apparatus>” in line 13, the apparatus A (MFP_A) performs a sub-process using the scan function. The processing condition (the scan condition) includes sub-conditions “document size”, “resolution”, “color mode”, “storage location”, “variable”, and “file name”.

When power consumption required when each of the image processing apparatuses 10 performs each of the sub-processes is compared with one another by referring to FIG. 5, the apparatus A consumes the lowest electricity when a scan process is performed. Accordingly, the cooperative apparatus information generating sub-unit 26 sets the apparatus A in the apparatus information as an execution responsible apparatus for the scan sub-process.

The apparatuses for the resolution conversion sub-process are not registered in FIG. 5. In this example, it is assumed that the apparatus A consumes the lowest electricity when a resolution conversion sub-process is performed. Accordingly, the cooperative apparatus information generating sub-unit 26 sets the apparatus A in the apparatus information as an execution responsible apparatus for the resolution conversion sub-process.

Similarly, for a print and output sub-process, the apparatus D consumes the lowest electricity. Accordingly, the cooperative apparatus information generating sub-unit 26 sets the apparatus D in the apparatus information as an execution responsible apparatus for the print and output sub-process. For a FAX sub-process, the apparatus C consumes the lowest electricity. Accordingly, the cooperative apparatus information generating sub-unit 26 sets the apparatus C in the apparatus information as an execution responsible apparatus for the FAX sub-process.

Subsequently, the cooperation definition information editing unit 30 compares the cooperation definition information illustrated in FIG. 7 with the execution responsible apparatuses selected by the cooperative apparatus information generating sub-unit 26 in the above-described manner. Then, the execution responsible apparatuses specified in the cooperation definition information differ from the execution responsible apparatuses selected in the apparatus information generated by the cooperative apparatus information generating sub-unit 26 in terms of the resolution conversion sub-process, the print and output sub-process, and the FAX sub-process. Therefore, the cooperation definition information editing unit 30 updates the processing apparatuses registered in the cooperation definition information for these sub-processes to the execution responsible apparatuses selected in the apparatus information generated by the cooperative apparatus information generating sub-unit 26.

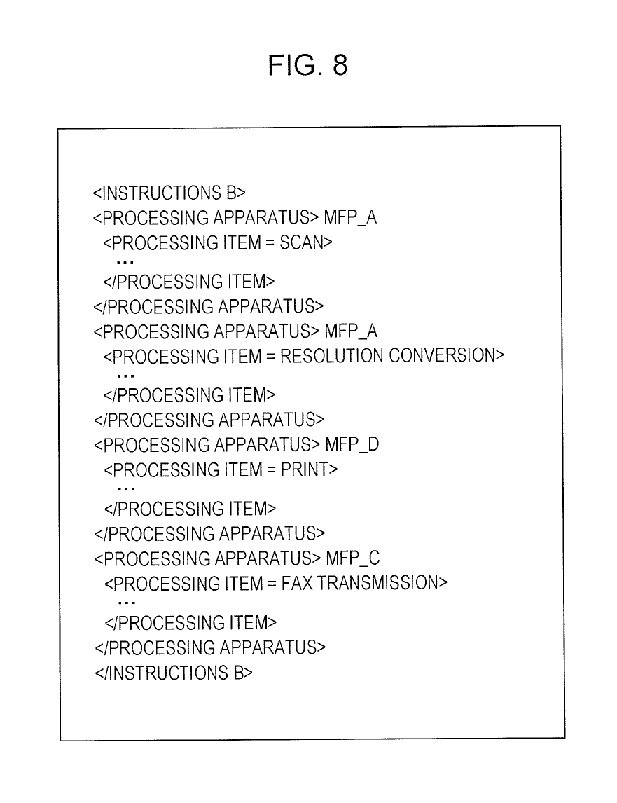

FIG. 8 illustrates the cooperation definition information after editing is performed by the cooperation definition information editing unit 30. Note that the processing conditions are not illustrated in FIG. 8. As can be seen from comparison of the cooperation definition information illustrated in FIG. 7 and the cooperation definition information illustrated in FIG. 8, the processing apparatuses for the resolution conversion sub-process, the print and output sub-process, and the FAX sub-process are changed into the execution responsible apparatuses selected by the cooperative apparatus information generating sub-unit 26 in the above-described manner.

The case in which the apparatus D is in a low power mode (a power saving mode) when a cooperative process based on the cooperation definition information illustrated in FIG. 7 is started is discussed below. In such a case, the power consumption when the apparatus resumes from the low power mode (Resume 2) is added to the power consumption required when the apparatus D performs a print and output sub-process. Thus, the image processing apparatus 10 that consumes the lowest electricity for the print and output sub-process is the apparatus C. Therefore, the cooperative apparatus information generating sub-unit 26 changes the apparatus D registered in the apparatus information as an execution responsible apparatus for the print and output sub-process into the apparatus C.

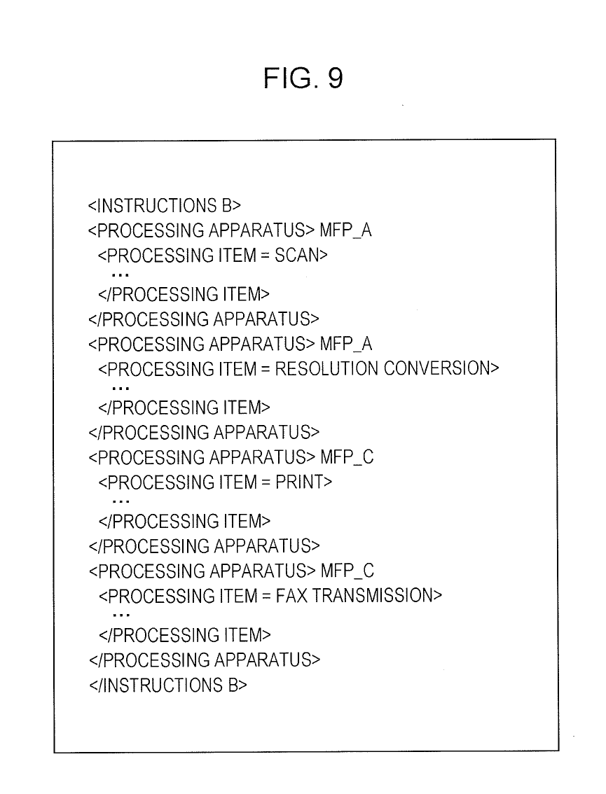

FIG. 9 illustrates the cooperation definition information after editing is performed by the cooperation definition information editing unit 30 when the apparatus D is in a power saving mode. As can be seen from comparison of the cooperation definition information illustrated in FIG. 8 and the cooperation definition information illustrated in FIG. 9, the processing apparatus for the print and output sub-process is changed from the apparatus D (MFP_D) into the apparatus C (MFP_C).

In some cooperative processes, it is desirable that the original cooperation definition information be unchanged regardless of the power consumption values. For example, in a scan sub-process in which a user directly operates the image processing apparatus 10, the image processing apparatus 10 operated by the user cannot be replaced with a different image processing apparatus 10. In addition, in a print and output sub-process in which a sheet, for example, subjected to processing is ejected, the sheet needs to be ejected from the image processing apparatus 10 that the user desires. According to the present exemplary embodiment, it may be determined that the cooperation definition information editing unit 30 does not change the cooperation definition information regardless of the apparatus information generated by the cooperative apparatus information generating sub-unit 26 in accordance with the way of processing and the processing order. Such a condition for not changing the cooperation definition information can be set in accordance with the actually performed operation.

In addition, as described above, the image processing apparatus 10 having low power consumption may be selected as an apparatus for executing a sub-process included in the cooperative process. Thereafter, the cooperation definition information in which the information regarding the apparatus for executing the sub-process is updated may be generated and stored in a storage unit (for example, the HDD 14 illustrated in FIG. 1) of the apparatus. By doing so, when the cooperation definition information is used next time, the image processing apparatus 10 having the lowest power consumption can be selected as the apparatus for executing the sub-process described in the cooperation definition information, and the sub-process can be executed.

When the cooperation definition information is updated and stored, a property indicating that the information is optimized in terms of power consumption may be stored together with the date and time. By doing so, it can be determined from the property of the cooperation definition information whether the cooperation definition information is updated so that an appropriate apparatus performs the sub-process in terms of power consumption when the cooperative process is previously performed in accordance with the cooperation definition information. Thus, when cooperative process is performed using the cooperation definition information next time and if it is determined that the cooperation definition information has been updated, the cooperative process may be executed without performing the optimization process in terms of power consumption. In such a case, if a period of time from the update time to the next execution time is within a predetermined period of time (a predetermined elapsed time), the computation of the power consumption of each of the apparatuses and performance of the optimization process may be removed. In contrast, if a period of time from the update time and the next execution time using the cooperation definition information is longer than the predetermined period of time, the computation of the power consumption of each of the apparatuses that can execute the sub-processes may be performed again, and the apparatuses that can perform the sub-processes with the lowest power consumption may be selected. This is because if a period of time longer than the predetermined period of time has elapsed, a new image processing apparatus 10 may have been installed or the power consumption table may have been updated. As a result, the combination of the apparatuses that consumes the lowest electricity previously set (updated) in the cooperation definition information may not be the combination that consumes the lowest electricity any more after the predetermined period of time has elapsed. Note that the predetermined period of time since the previous update time may be independently determined for each of the sub-processes.

In addition, as described in the above exemplary embodiment, instead of defining a particular apparatus for processing a sub-process and changing the apparatus for processing the sub-process, a condition that a sub-process is performed by an apparatus having the lowest power consumption may be defined in the cooperation definition information. In such a case, for example, when a sub-process is performed and the image processing apparatus 10 that analyzes the cooperation definition information analyzes the definition information regarding the apparatus that performs a sub-process, the image processing apparatus 10 determines whether the condition that a sub-process is performed by an apparatus having the lowest power consumption. If the definition is included, the image processing apparatus 10 that can perform the sub-process included in the cooperative process is searched for. Thereafter, among the image processing apparatuses 10 extracted through the search operation, the image processing apparatus 10 having the lowest power consumption when performing the sub-process is selected. Subsequently, the image processing apparatus 10 that analyzes the cooperation definition information instructs the selected image processing apparatus 10 to perform the sub-process.

### Other Configuration of Third Exemplary Embodiment

While the third exemplary embodiment has been described with reference to the example in which the cooperation definition information is sequentially transferred to the image processing apparatuses 10 and a cooperative process is performed, the following system may be used. That is, in the system, a controller that performs overall control of the plural image processing apparatuses 10 has the cooperation definition information and controls each of the image processing apparatuses 10 on the basis of the cooperation definition information so as to execute a series of jobs. In such a case, the controller may be formed from a computer (e.g., a personal computer) provided in addition to the image processing apparatuses 10 or the controller (e.g., the CPU 11 illustrated in FIG. 11) of one of the image processing apparatuses 10.

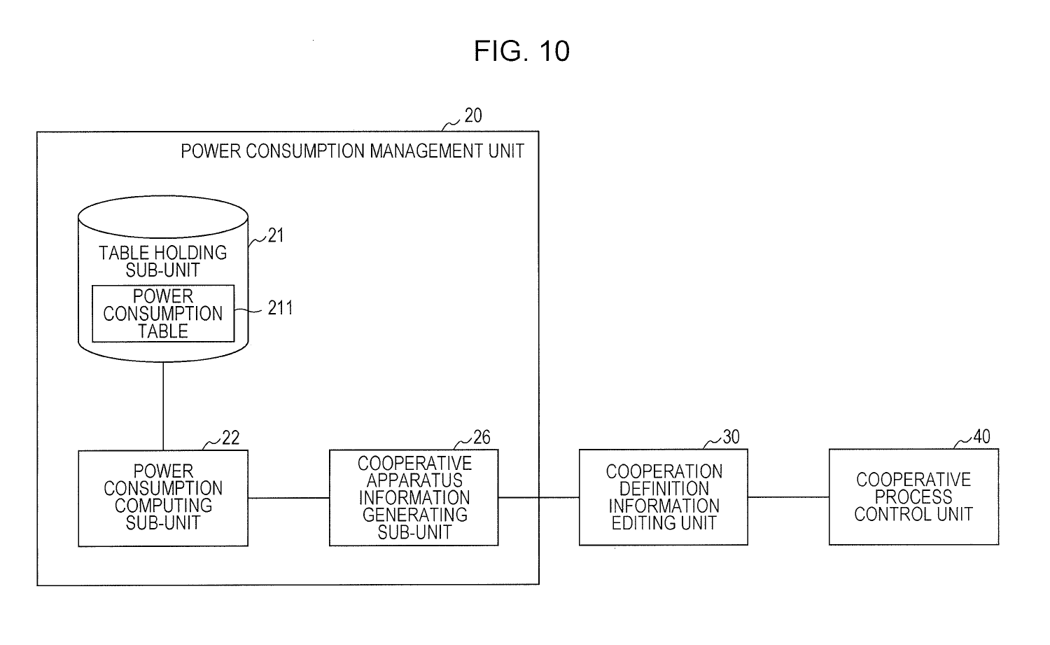

FIG. 10 illustrates an example of the functional configuration of a controller of such a system. As illustrated in FIG. 10, the controller includes a power consumption management unit 20, a cooperation definition information editing unit 30, and a cooperative process control unit 40. The power consumption management unit 20 includes a table holding sub-unit 21, a power consumption computing sub-unit 22, and a cooperative apparatus information generating sub-unit 26. These units have functions that are the same as those of the power consumption management unit 20 illustrated in FIG. 6. In addition, the cooperation definition information editing unit 30 is similar to the cooperation definition information editing unit 30 illustrated in FIG. 6. The functions substantially the same as those of the above-described exemplary embodiment are given the same reference numerals as those used for corresponding functions of the above-described exemplary embodiment, and the descriptions thereof are not repeated. Note that as illustrated in FIG. 10, the power consumption management unit 20 of the controller of the system does not have a function corresponding to that of the job information acquiring sub-unit 23. The power consumption management unit 20 may include the job information storage sub-unit 24 and the information output sub-unit 25. However, these units are not always needed.

In the controller of the system, the cooperative process control unit 40 transmits job execution instructions for a cooperative process to control units to be controlled (i.e., the image processing apparatuses 10 under the control) on the basis of the cooperation definition information edited by the cooperation definition information editing unit 30 as needed. If one of the image processing apparatuses 10 includes the controller of the system, the image processing apparatus 10 including the controller is regarded as one of the units to be controlled.

While each of the above-described exemplary embodiments has been described with reference to a multi-function peripheral including the image input terminal 16 and the image forming unit 17 illustrated in FIG. 1 as the image processing apparatus 10, the image processing apparatus 10 is not limited thereto. For example, an apparatus having a certain image processing function, such as a copy machine, a printer, a scanner, or a FAX having a single function, may be used as the image processing apparatus 10. In addition, while each of the above-described exemplary embodiments has been described with reference to the example in which a program to be executed by the CPU is stored in a storage unit such as the ROM 13 illustrated in FIG. 1, the storage unit is not limited thereto. For example, the program may be stored in a storage unit other than the ROM 13 (e.g., the HDD 14) or an external storage unit. Alternatively, the program may be received from the outside via a communication line, such as a network, in the form of a data signal. Still alternatively, the program may be stored in a computer-readable storage medium, such as a digital versatile disk-read only memory (a DVD-ROM) and may be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a table holding unit that holds a power consumption table in which a premeasured power consumption value is registered for each of functions provided by the image processing apparatus;
a power consumption computing unit that computes, using the power consumption table, power consumed when a process using at least one of the functions is performed; and
a memory that stores information regarding the power consumption in association with the performed process.

2. The image processing apparatus according to claim 1, wherein the table holding unit further holds the power consumption table in which a power consumption value is registered for each of the functions when the function is executed by an image processing apparatus different from the image processing apparatus,
wherein when an execution instruction for a process using the function is submitted, the power consumption computing unit computes power consumed when the image processing apparatus performs the process and power consumed when the different image processing apparatus performs the process on the basis of the power consumption table, and
wherein the memory stores the power consumption information regarding the image processing apparatus and the power consumption information regarding the different image processing apparatus in association with the performed process.

3. The image processing apparatus according to claim 2, further comprising:
an editing unit that edits cooperation definition information used for performing a cooperative process including sub-processes cooperatively performed by a plurality of the image processing apparatuses;
wherein the table holding unit holds the power consumption table regarding the different image processing apparatus capable of performing the cooperative process together with at least the image processing apparatus,
wherein the power consumption computing unit computes values of power consumed when the image processing apparatus and the different image processing apparatus perform each of the sub-processes of the cooperative process, and
wherein the editing unit edits the cooperation definition information so that total power consumption for the cooperative process is further reduced on the basis of the values of power that are consumed when the image processing apparatus and the different image processing apparatus perform each of the sub-processes of the cooperative process for which the execution instruction is submitted and that are computed by the power consumption computing unit.

4. The image processing apparatus according to claim 2, further comprising:
an apparatus information output unit;
wherein if the value of power consumed when the different image processing apparatus performs any one of the sub-process and computed by the power consumption computing unit is smaller than the value of power consumed when the image processing apparatus performs the sub-process, the apparatus information output unit outputs at least one of a message indicating that the value of power consumed when the different image processing apparatus performs the sub-process is smaller than the value of power consumed when the image processing apparatus performs the sub-process and a message prompting a user to perform the process using the different image processing apparatus.

5. The image processing apparatus according to claim 1, further comprising:
an information acquiring unit that acquires processing information regarding a process on the basis of an execution instruction of the process and a result of performance of the process;
wherein the memory stores the processing information acquired by the information acquiring unit in association with the power consumption information for each of the processes.

6. The image processing apparatus according to claim 1, further comprising:
a power consumption information output unit that reads the power consumption information stored in the memory using an extraction condition regarding a submitter of the execution instruction of the process and outputs the readout power consumption information.

7. A system comprising:
a table holding unit that holds a power consumption table in which power consumption values premeasured when a plurality of image processing apparatus perform each of functions are registered;
a power consumption computing unit that, when an execution instruction for a process using one of the functions is submitted, computes a value of power consumed when each of the image processing apparatuses performs the process on the basis of the power consumption table; and
a selecting unit that selects one of the image processing apparatuses that is responsible for performing a specific one of the processes on the basis of the power consumption values computed by the power consumption computing unit.

8. The system according to claim 7, further comprising:
an editing unit that edits cooperation definition information used for performing a cooperative process including sub-processes cooperatively performed by a plurality of the image processing apparatuses;
wherein when an execution instruction for the cooperative process is submitted, the power consumption computing unit computes values of power consumed when each of the image processing apparatuses performs each of the sub-processes of the cooperative process, and
wherein the editing unit edits the cooperation definition information so that total power consumption of the cooperative process is further reduced on the basis of the values of power consumed when the image processing apparatuses perform the sub-processes of the cooperative process for which the execution instruction is submitted and that are computed by the power consumption computing unit.

9. A computer readable medium storing a program causing a computer to execute a process for controlling an image processing apparatus, the process comprising:
when an execution instruction of a process using at least one of functions that the image processing apparatus provides is submitted, computing, using the power consumption table in which a premeasured power consumption value is registered for each of functions, power consumed when the process is performed; and
storing information regarding the computed power consumption in association with the performed process.

10. The computer readable medium according to claim 9, wherein the computing further involves, when an execution instruction for a process using the function is submitted, computing, using the power consumption table in which a power consumption value is registered for each of the functions when the function is executed by an image processing apparatus different from the image processing apparatus, power consumed when the different image processing apparatus performs the process; and
storing the power consumption information regarding the image processing apparatus and the power consumption information regarding the different image processing apparatus in association with the performed process.

11. The computer readable medium according to claim 10, wherein the process further comprises editing cooperation definition information used when a cooperative process including sub-processes cooperatively performed by a plurality of image processing apparatuses is performed,
wherein, when an execution instruction of the cooperative process is submitted, computing further includes computing values of power consumed when the image processing apparatus and the different image processing apparatus perform each of the sub-processes of the cooperative process, and
wherein the editing includes editing the cooperation definition information so that total power consumption of the cooperative process is further reduced on the basis of the power consumption values that are computed for the sub-processes of the cooperative process for which the execution instruction is submitted and that are consumed when the image processing apparatus and the different image processing apparatus perform the sub-processes.

12. An image processing method comprising:
computing, using a power consumption table in which a premeasured power consumption value is registered for each of functions provided by the image processing apparatus, power consumed when a process using at least one of the functions is performed; and
storing information regarding the power consumption in association with the performed process.
